(19) United States
(12) Patent Application Publication
(10) Pub. No.: US 2015/0007658 A1
(43) Pub. Date: Jan. 8, 2015

(54) MOTION DETECTION DEVICE AND MOTION ANALYSIS SYSTEM

(71) Applicant: Seiko Epson Corporation, Tokyo (JP)

(72) Inventors: Yuya ISHIKAWA, Chino-shi (JP); Kenya KODAIRA, Azumino-shi (JP)

(21) Appl. No.: 14/309,446

(22) Filed: Jun. 19, 2014

(30) Foreign Application Priority Data
Jul. 5, 2013 (JP) 2013-141722

(51) Int. Cl. G01P 13/00; G01P 15/00; G01P 3/00

(52) U.S. Cl. CPC G01P 13/00; G01P 3/00; G01P 15/00
USPC 73/514.35; 73/488

(57) ABSTRACT

A motion detection device specifies a movement of at least one of a subject and a sporting gear as an indicator of a trigger signal, using an output from an inertial sensor. The movement of at least one of the subject and the sporting gear is specified in the output from the inertial sensor. The trigger signal is generated according to the specified movement. The subject causes the trigger signal to be generated at proper timing through his or her own movement.

### BACKGROUND

1. Technical Field

The present invention relates to a motion detection device and a motion analysis system utilizing the motion detection device.

2. Related Art

For example, JP-A-2011-210 discloses a swing analysis system as a specific example of a motion analysis system. A three-dimensional acceleration sensor is attached to a subject. The subject's golf swing is analyzed, based on an output from the three-dimensional acceleration sensor. See JP-A-2011-78753 and JP-A-2000-148351 as well.

A golf swing starts with the address, goes through the backswing, downswing and impact, then goes on to the follow-through, and reaches the finish. It is desirable that analysis of a golf swing should start at the address. In JP-A-2011-210, the swing analysis system is operated by an observer. The observer can confirm the address posture of the subject and start measuring the subject's swing. In such a swing analysis system, measurement of a swing cannot be started at proper timing in the absence of the observer. It is desirable that measurement of a swing securely starts at the address even when the subject is by himself or herself.

### SUMMARY

An advantage of some aspects of the invention is to provide a motion detection device and a motion analysis system which are capable of starting measurement of a swing securely at proper timing even when the subject is by himself or herself.

(1) An aspect of the invention relates to a motion detection device that specifies a movement of at least one of a subject and a sporting gear as an indicator of a trigger signal, using an output from an inertial sensor.

The inertial sensor outputs a detection signal during a series of movements of the subject or the sporting gear. In the motion detection device, the movement of at least one of the subject and the sporting gear is specified in the output from the inertial sensor. The trigger signal is generated according to the specified movement. The subject can cause the trigger signal to be generated at proper timing through his or her own movement.

(2) The indicator may include a repetition of the movement. Generally, there are few exercises that include a repetition of a specific movement during a predetermined period. If the duration of the period is adjusted, the exercise does not include a repetitive movement during the period. Therefore, a repetition of a movement detected during such a period can be considered to be an intentional movement by the subject. Such a repetition of the movement is very unlikely to be mistaken for another movement. Therefore, erroneous output of the trigger signal can be prevented.

(3) The indicator may include the movement and a movement in an opposite direction to the movement. Generally, there are few exercises in which a specific movement and a movement in the opposite direction paired with the specific movement (for example, a mirror image) continue during a predetermined period. If the duration of the period is adjusted, the exercise does not include a continuation of a specific movement and a movement in the opposite direction during the period. Therefore, a continuation of a movement and a movement in the opposite direction during such a period can be considered to be an intentional movement by the subject. Such a continuation of the movement and the movement in the opposite direction is very unlikely to be mistaken for another movement. Therefore, erroneous output of the trigger signal can be prevented.

(4) The motion detection device may include a memory which stores the indicator. If the indicator stored in the memory is specified in the output from the inertial sensor, the trigger signal is generated.

(5) The memory may store a peak part of the output from the inertial sensor as the indicator. If the peak part stored in the memory is specified in the output from the inertial sensor, the trigger signal is generated.

(6) The memory may store plural peak parts of the output from the inertial sensor as the indicator. If the plural peak parts stored in the memory are specified in the output from the inertial sensor, the trigger signal is generated.

(7) The memory may store the output from the inertial sensor in a static state of at least one of the subject and the sporting gear on which the inertial sensor is installed. In such a static state, the output from the inertial sensor represents a detection signal having a substantially constant value. Therefore, the movement to be the indicator can become conspicuous in the output. The indicator is thus securely found in the output from the inertial sensor. The indicator is prevented from being overlooked.

(8) The memory may store the indicator for each subject. The indicator is thus customized for each subject. Output of the trigger signal is reliably secured for subject.

(9) The memory may be loaded in a sensor unit in which the inertial sensor is loaded. The memory is thus incorporated into the sensor unit. The sensor unit itself functions as a motion detection device.

(10) The motion detection device may include a calculation circuit which, if the indicator is detected from the output from the inertial sensor, outputs the trigger signal and instructs a main body unit to carry out processing. The calculation circuit can be configured separately from the main body unit. The burden on the main body unit is thus reduced.

(11) In the motion detection device, a first indicator and a second indicator may be specified as the indicator. The calculation circuit may output the trigger signal to the main body unit to start measurement if the first indicator is detected from the output from the inertial sensor, and may output the trigger signal to the main body unit to stop measurement if the second indicator is detected from the output from the inertial sensor. Thus, the subject can manage the start and stop of measurement through his or her own movement. The subject can realize the start and stop of measurement at proper timing.

(12) The calculation circuit may be loaded in a sensor unit in which the inertial sensor is loaded. The calculation circuit is thus incorporated into the sensor unit. The sensor unit itself functions as a motion detection device.

(13) The inertial sensor may be an angular velocity sensor. The motion detection device may specify the indicator, using an angular velocity generated about an axis of a shaft portion of the sporting gear. The inertial sensor outputs an angular velocity signal. The movement of at least one of the subject and the sporting gear is specified according to the angular velocity.

(14) The inertial sensor may be an acceleration sensor. The motion detection device may specify the indicator, using an acceleration generated in the sporting gear. The inertial sensor outputs an acceleration signal. The movement of at least one of the subject and the sporting gear is specified according to the acceleration signal.

(15) The motion detection device may be incorporated and utilized in a motion analysis system. In this case, the motion analysis system may include the motion detection device and the main body unit which executes processing in response to reception of the trigger signal.

(16) The main body unit may process the output from the inertial sensor at a first sampling rate before receiving the trigger signal and may process the output from the inertial sensor at a second sampling rate that is higher than the first sampling rate in response to reception of the trigger signal. The main body unit waits for execution of processing operation until the trigger signal is received. At this point, the main body unit processes the output from the inertial sensor at the first sampling rate. As the trigger signal is received, the main body unit processes the output from the inertial sensor at the second sampling rate. Therefore, resolution of motion analysis can be increased. The frequency of signal processing at the time of waiting is lowered. Therefore, unnecessary energy consumption can be restrained.

(17) The trigger signal may be a signal indicating start or stop of execution of processing by the main body unit. Thus, the subject can manage the start and stop of measurement through his or her own movement. The subject can realize the start and stop of measurement at proper timing.

(18) Another aspect of the invention relates to a motion detection device that includes: a unit which stores a movement of a subject or a sporting gear as an indicator, using an output from an inertial sensor; and a unit which outputs a trigger signal to a main body unit if the indicator is detected from the output from the inertial sensor.

### BRIEF DESCRIPTION OF THE DRAWINGS

The invention will be described with reference to the accompanying drawings, wherein like numbers reference like elements.

FIG. 1 is a conceptual view schematically showing the configuration of a golf swing analysis system according to a first embodiment of the invention.

FIG. 2 is a conceptual view schematically showing the relation between a motion analysis model, and a golfer and a golf club.

FIG. 3 is a block diagram schematically showing the configuration of a calculation processing circuit according to the first embodiment.

FIG. 4 is a conceptual view schematically showing a specific movement according to a first specific example.

FIG. 5 is a graph schematically showing an indicator specifying the specific movement according to the first specific example.

FIG. 6 is a conceptual view schematically showing a specific movement according to a second specific example.

FIG. 7 is a graph schematically showing an indicator specifying the specific movement according to the second specific example.

FIG. 8 is a conceptual view schematically showing a specific movement according to a third specific example.

FIG. 9 is a graph schematically showing an indicator specifying the specific movement according to the third specific example.

FIG. 10 is a conceptual view schematically showing a specific movement according to a fourth specific example.

FIG. 11 is a graph schematically showing an indicator specifying the specific movement according to the fourth specific example.

FIG. 12 is a conceptual view schematically showing the configuration of a golf swing analysis system according to a second embodiment of the invention.

FIG. 13 is a conceptual view schematically showing the configuration of a golf swing analysis system according to a comparative example.

FIG. 14 is a conceptual view schematically showing the configuration of a golf swing analysis system according to another comparative example.

### DESCRIPTION OF EXEMPLARY EMBODIMENTS

Hereinafter, an embodiment of the invention will be described with reference to the accompanying drawings. The following embodiment should not unduly limit the content of the invention described in the appended claims. Not all the configurations described in this embodiment are necessarily essential as elements of the invention.

### 1. Configuration of Golf Swing Analysis System According to First Embodiment

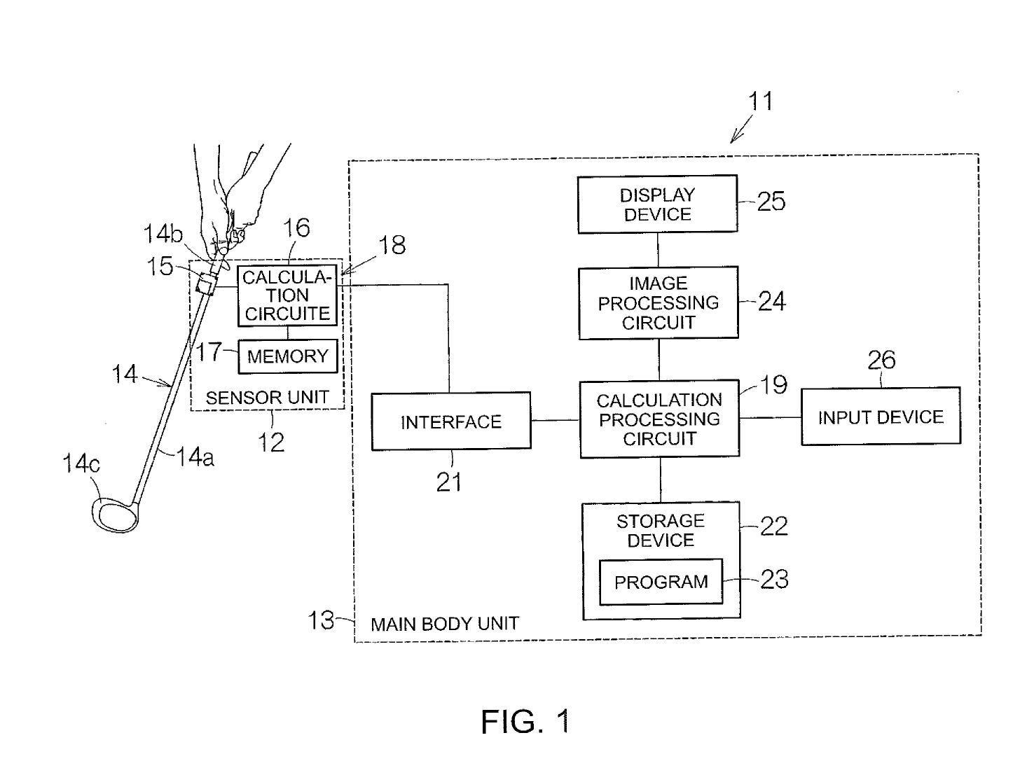

FIG. 1 schematically shows the configuration of a golf swing analysis system (motion analysis system) 11 according to a first embodiment of the invention. The golf swing analysis system 11 has, for example, a sensor unit 12 and a main body unit 13. The sensor unit 12 is attached to a golf club (sporting gear) 14. The golf club 14 includes a shaft 14a and a grip 14b. The grip 14b is gripped by the subject's hands. The grip 14b is formed coaxially with a center axis of the shaft 14a. A club head 14c is connected to a distal end of the shaft 14a. Preferably, the sensor unit 12 is attached to the shaft 14a or the grip 14b of the golf club 14. The sensor unit 12 may be fixed so that the sensor unit 12 cannot move relative to the golf club 14. The sensor unit 12 may be thus installed on the golf club 14. Alternatively, the sensor unit 12 may be attached to the subject's hand, arm or shoulder.

The sensor unit 12 has an inertial sensor 15. An acceleration sensor and a gyro sensor are incorporated in the inertial sensor 15. The acceleration sensor can detect an acceleration in each of three-axis directions orthogonal to each other. The gyro sensor can detect an angular velocity about each of three axes orthogonal to each other. The inertial sensor 15 outputs a detection signal. Based on the detection signal, the acceleration and angular velocity for each axis are specified. The acceleration sensor and the gyro sensor detect information of acceleration and angular velocity with relatively high accuracy. Here, when installing the sensor unit 12, one of detection axes of the inertial sensor 15 is aligned with the center axis of the shaft 14a. That is, a y-axis of the inertial sensor 15 overlaps with or extends parallel to the center axis of the shaft 14a.

The sensor unit 12 has a calculation circuit 16 and a memory 17. The calculation circuit 16 is connected to the inertial sensor 15. The calculation circuit 16 receives an output from the inertial sensor 15. The memory 17 is connected to the calculation circuit 16. The memory 17 stores an indicator that is expressed by the output from the inertial sensor 15 and that specifies a specific movement of the golf club 14. The specific movement will be described in detail later. The indicator includes a first indicator, a second indicator, and a third indicator. If the first indicator is detected in an output signal from the inertial sensor 15 while receiving the output signal from the inertial sensor 15, the calculation circuit 16 outputs a start signal (trigger signal). Similarly, if the second indicator is detected in the output signal from the inertial sensor 15, the calculation circuit 16 outputs an end signal (trigger signal). Similarly, if the third indicator is detected in the output signal from the inertial sensor 15, the calculation circuit 16 outputs a static state notification signal. That is, the third indicator corresponds to an output from the inertial sensor 15 in a static state of the golf club 14. The calculation circuit 16 determines the static state of the golf club 14, based on the output from the inertial sensor 15. The third indicator may be specified, for example, as a threshold value. As the threshold value, a value that can eliminate the influence of a detection signal indicating micro-vibration such as body motion may be set. If the output from the inertial sensor 15 is below the threshold value, the calculation circuit 16 determines that the golf club 14 is in the static state. If the static state is detected over a predetermined period, the calculation circuit 16 generates the static state notification signal. The inertial sensor 15, the calculation circuit 16 and the memory 17 may be accommodated in a common casing of the sensor unit 12. Here, the calculation circuit 16 and the memory 17 form a motion detection device 18. The motion detection device 18 specifies the movement of the golf club 14, which is at least one of the subject and the sporting gear, as the indicator of the trigger signal, using the output from the inertial sensor 15.

The main body unit 13 has a calculation processing circuit 19. The sensor unit 12 is connected to the calculation processing circuit 19. For this connection, a predetermined interface circuit 21 is connected to the calculation processing circuit 19. The interface circuit 21 may be wired to the sensor unit 12 or wirelessly connected to the sensor unit 12. The output from the inertial sensor 15, that is, the detection signal, the start signal and the end signal are inputted to the calculation processing circuit 19 from the sensor unit 12.

A storage device 22 is connected to the calculation processing circuit 19. In the storage device 22, for example, a golf swing analysis software program 23 and related data are stored. The calculation processing circuit 19 executes the golf swing analysis software program 23 to realize a golf swing analysis method. The storage device 22 includes a DRAM (dynamic random access memory), a large-capacity storage unit, a non-volatile memory or the like. For example, in the DRAM, the golf swing analysis software program 23 is temporarily held when carrying out the golf swing analysis method. In the large-capacity storage unit such as a hard disk drive (HDD), the golf swing analysis software program and data are saved. In the non-volatile memory, a relatively small-capacity program such as BIOS (basic input/output system) and data are stored.

An image processing circuit 24 is connected to the calculation processing circuit 19. The calculation processing circuit 19 sends predetermined image data to the image processing circuit 24. A display device 25 is connected to the image processing circuit 24. For this connection, a predetermined interface circuit (not shown) is connected to the image processing circuit 24. The image processing circuit 24 sends an image signal to the display device 25, according to the image data inputted thereto. An image specified by the image signal is displayed on a screen of the display device 25. As the display device 25, a liquid crystal display or another type of flat panel display is used. Here, the calculation processing circuit 19, the storage device 22 and the image processing circuit 24 can be provided, for example, as a computer device.

An input device 26 is connected to the calculation processing circuit 19. The input device 26 has at least alphabetical keys and ten keys. Letter information and numerical value information are inputted to the calculation processing circuit 19 from the input device 26. The input device 26 may include, for example, a keyboard. Here, the main body unit 13 can be configured as a smartphone, tablet PC (personal computer), or mobile phone terminal.

### 2. Motion Analysis Model

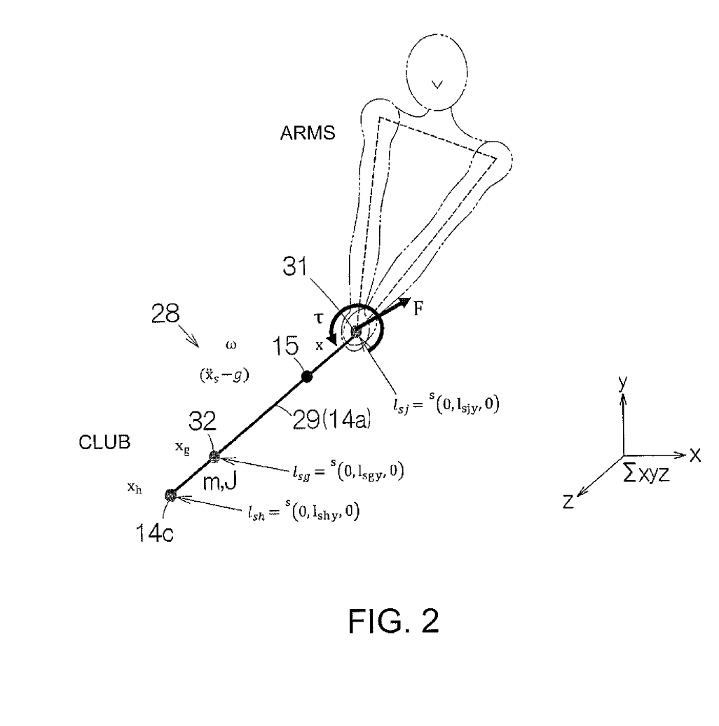

The calculation processing circuit 19 prescribes an imaginary space. The imaginary space is formed as a three-dimensional space. As shown in FIG. 2, the three-dimensional space has an absolute reference coordinate system (overall coordinate system) Σ_{xyz}. In the three-dimensional space, a three-dimensional motion analysis model 28 is constructed in accordance with the absolute reference coordinate system Σ_{xyz}. A bar 29 in the three-dimensional motion analysis model 28 is point-constrained at a support 31 (coordinate x). The bar 29 acts as a pendulum three-dimensionally about the support 31. The position of the support 31 can be moved. Here, according to the absolute reference coordinate system Σ_{xyz}, the position of a center of gravity 32 of the bar 29 is specified by a coordinate x_{g} and the position of the club head 14c is specified by a coordinate xₕ.

The three-dimensional motion analysis model 28 is equivalent to a modeling of the golf club 14 at the time of a swing. The pendulum bar 29 projects the shaft 14a of the golf club 14. The support 31 of the bar 29 projects the grip 14b. The sensor unit 12 is fixed on the bar 29. According to the absolute reference coordinate system Σ_{xyz}, the position of the inertial sensor 15 is specified by a coordinate xₛ. The inertial sensor 15 outputs an acceleration signal and an angular velocity signal. The acceleration signal specifies an acceleration minus the influence of gravitational acceleration g, that is, (\ddot{X}ₛ−g). The angular velocity signal specifies angular velocities ω₁, ω₂.

The calculation processing circuit 19 similarly fixes a local coordinate system Σₛ on the inertial sensor 15. The origin of the local coordinate system Σₛ is set at the origin of a detection axis of the inertial sensor 15. The y-axis of the local coordinate system Σₛ coincides with the axis of the shaft 14a. The x-axis of the local coordinate system Σₛ coincides with the ball hitting direction that is specified by the direction of the face. Therefore, according to the local coordinate system Σₛ, a position lₛⱼ of the support 31 is specified by (0, l_{sjy}, 0). Similarly, on this local coordinate system Σₛ, a position l_{sg} of the center of gravity 32 is specified by (0, l_{sgy}, 0), and a position lₛₕ of the club head 14c is specified by (0, l_{shy}, 0).

### 3. Configuration of Calculation Processing Circuit

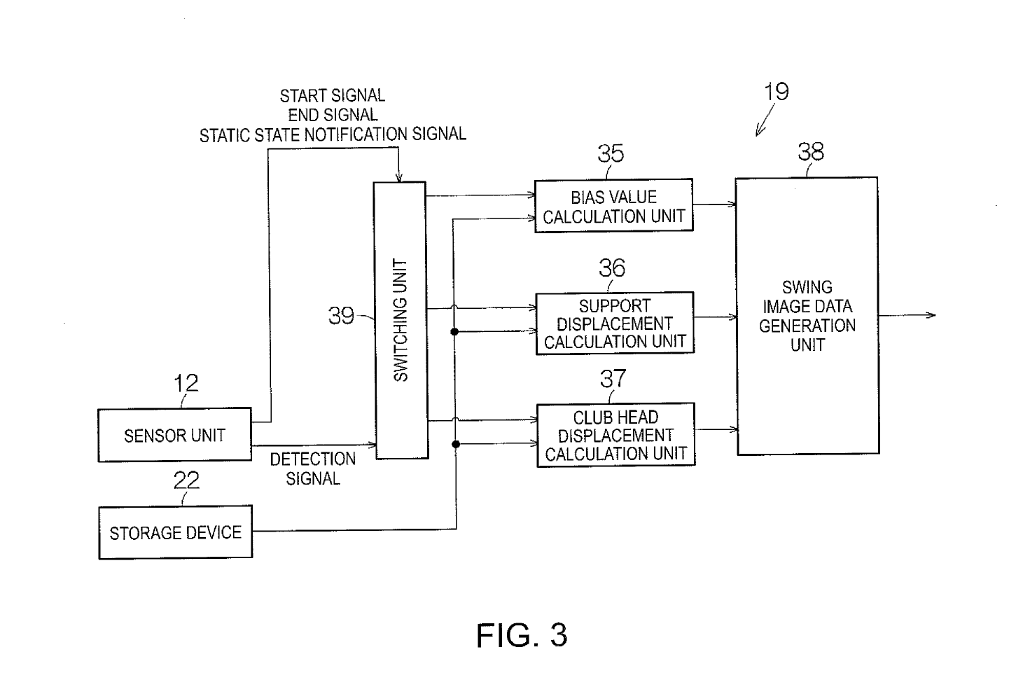

FIG. 3 schematically shows the configuration of the calculation processing circuit 19 according to the one embodiment. The calculation processing circuit 19 has a bias value calculation unit 35. The bias value calculation unit 35 is connected, for example, to the calculation circuit 16 of the sensor unit 12. The bias value calculation unit 35 calculates a bias value of the inertial sensor 15, based on the output from the inertial sensor 15. The bias value can be specified based on the detection signal outputted from the inertial sensor 15 in the static state. The bias value calculation unit 35 finds a bias estimate value that is a function of time, based on information of the position of the club head 14c and the position of the grip end acquired during a predetermined period. To derive the bias estimate value, data is sampled at an arbitrary time interval and linearly approximated on a two-dimensional plane including a time axis. Here, the bias is a general term for an error including zero-bias in the initial state where angular velocity is zero and random drifts due to external factors such as power supply fluctuations and temperature fluctuations.

The calculation processing circuit 19 has a support displacement calculation unit 36 and a club head displacement calculation unit 37. The acceleration signal and the angular velocity signal are inputted to the support displacement calculation unit 36 from the inertial sensor 15. Based on the acceleration and the angular velocity, the support displacement calculation unit 36 calculates the displacement of the support 31 according to the time axis. For example, if the displacement of the inertial sensor 15 and the posture of the bar 29 are specified, the displacement of the support 31 can be specified. The displacement of the inertial sensor 15 can be calculated based on the acceleration from the inertial sensor 15. The posture of the bar 29 can be calculated based on the angular velocity from the inertial sensor 15. In this calculation, the support displacement calculation unit 36 acquires various numerical data including grip end data from the storage device 22. The grip end data specifies the position of the grip end, that is, the position lₛⱼ of the support 31, for example, according to the local coordinate system Σₛ of the inertial sensor 15. Also, in specifying the position of the support 31, the length of the golf club 14 may be specified and the position of the inertial sensor 15 on the golf club 14 may be thus specified. The coordinates of the position of the support 31 are transformed from the local coordinate system Σₛ of the inertial sensor 15 to the absolute reference coordinate system Σ_{xyz}. In this coordinate transformation, a transformation matrix can be supplied from the storage device 22.

The acceleration signal and the angular velocity signal are inputted to the club head displacement calculation unit 37 from the inertial sensor 15. Based on the acceleration and the angular velocity, the club head displacement calculation unit 37 calculates the displacement of the club head 14c according to the time axis. For example, if the displacement of the inertial sensor 15 and the posture of the bar 29 are specified, the displacement of the club head 14c can be specified within the local coordinate system Σₛ of the inertial sensor 15. The displacement of the inertial sensor 15 can be calculated based on the acceleration from the inertial sensor 15. The posture of the bar 29 can be calculated based on the angular velocity from the inertial sensor 15. In this calculation, the club head displacement calculation unit 37 acquires various numerical data including club head data from the storage device 22. The club head data specifies the position lₛₕ of the club head 14c, for example, according to the local coordinate system Σₛ of the inertial sensor 15. Also, in specifying the position of the club head 14c, the length of the golf club 14 may be specified and the position of the inertial sensor 15 on the golf club 14 may be thus specified. The coordinates of the position of the club head 14c are transformed from the local coordinate system Σₛ to the absolute reference coordinate system Σ_{xyz}. In such coordinate transformation, the club head displacement calculation unit 37 is notified of the position of the support 31 from the support displacement calculation unit 36.

The calculation processing circuit 19 has a swing image data generation unit 38. The swing image data generation unit 38 is connected to the bias value calculation unit 35, the support displacement calculation unit 36 and the club head displacement calculation unit 37. The swing image data generation unit 38 generates three-dimensional image data to visualize the movement trajectory of the bar 29 in three dimensions, based on the position of the support 31 and the position of the club head 14c along the time axis. In generating the three-dimensional image data, the swing image data generation unit 38 corrects the position of the support 31 and the position of the club head 14c, based on the bias estimate value.

The calculation processing circuit 19 has a switching unit 39. The bias value calculation unit 35, the support displacement calculation unit 36 and the club head displacement calculation unit 37 are connected to the switching unit 39. The detection signal, the start signal, the end signal and the static state notification signal are sent to the switching unit 39 from the sensor unit 12. Before receiving the start signal, the switching unit 39 processes the detection signal from the inertial sensor 15 at a first sampling rate. As the detection signal from the inertial sensor 15 is a temporally discrete value, the switching unit 39 thins out the discrete value at the first sampling rate. The detection signal is sent to the bias value calculation unit 35, the support displacement calculation unit 36 and the club head displacement calculation unit 37 at the first sampling rate. Meanwhile, the switching unit 39 processes the detection signal from the inertial sensor 15 at a second sampling rate that is higher than the first sampling rate, in response to reception of the start signal. The detection signal is sent to the bias value calculation unit 35, the support displacement calculation unit 36 and the club head displacement calculation unit 37 at the second sampling rate. The number of samples per unit time of the discrete value used in the calculation increases. Here, the first sampling rate is set, for example, at 250 Hz, and the second sampling rate is set, for example, at 1000 Hz. In this way, the switching unit 39 changes the frequency of processing the output from the inertial sensor 15 in response to the reception of the start signal sent from the calculation circuit 16. Moreover, the switching unit 39 switches the sampling rate from the second sampling rate to the first sampling rate in response to reception of the end signal. To realize the first sampling rate that is lower than the second sampling rate, the detection signal from the inertial sensor 15 may be thinned out at the time of the output from the sensor unit 12 (for example, at the time of the output from the calculation circuit 16), or may be thinned out at the time of the processing by the calculation processing circuit 19 (switching unit 39) after the reception by the main body unit 13.

### 4. Operation of Golf Swing Analysis System

The operation of the golf swing analysis system 11 will be described briefly. First, a golfer's golf swing is measured. Before the measurement, necessary information is inputted to the calculation processing circuit 19 from the input device 26. Here, according to the three-dimensional pendulum model 28, inputting the position lₛⱼ of the support 31 according to the local coordinate system Σₛ and a rotation matrix R⁰ of the initial posture of the inertial sensor 15 is prompted. The inputted information is managed, for example, under a specific identifier. The identifier may identify a specific golfer.

Before the measurement, the inertial sensor 15 is mounted on the shaft 14a of the golf club 14. The inertial sensor 15 is fixed so that the inertial sensor 15 cannot be displaced relative to the golf club 14. One of the detection axes of the inertial sensor 15 (here, the y-axis) is aligned with the center axis of the shaft 14a. Another one of the detection axes of the inertial sensor 15 (here, the x-axis) is aligned with the ball hitting direction specified by the direction of the face.

The measurement by the inertial sensor 15 is started before the execution of a golf swing. The inertial sensor 15 starts operating in response to an operation on a switch (not shown). At the start of the operation, the inertial sensor 15 is set in a predetermined position and posture. The position and posture correspond to the position and posture specified by the rotation matrix R⁰ of the initial posture. The inertial sensor 15 continuously measures acceleration and angular velocity at a specific sampling interval. The sampling interval prescribes the resolution of the measurement. A detection signal from the inertial sensor 15 is sent in real time to the calculation processing circuit 19. The calculation processing circuit 19 receives a signal specifying the output from the inertial sensor 15.

A golf swing starts with the address, goes through the backswing, downswing and impact, then goes on to the follow-through and reaches the finish. At the address, the posture of the subject is static. The calculation circuit 16 determines the static state of the golf club 14. If the output from the inertial sensor 15 is below a threshold value, the calculation circuit 16 understands that the golf club 14 is in the static state. The calculation circuit 16 outputs a static state notification signal. In response to reception of the static state notification signal, the bias value calculation unit 35 calculates the bias value of the inertial sensor 15. The calculated bias value is sent to the swing image data generation unit 38.

As the static state is thus secured, the subject can start the swing movement. The swing movement shifts from the address to the backswing, goes through the downswing and impact, then goes on to the follow-through, and reaches the finish. The golf club 14 is swung. When swung, the golf club 14 changes its posture according to the time axis. The inertial sensor 15 outputs a detection signal in accordance with the posture of the golf club 14. The support displacement calculation unit 36 and the club head displacement calculation unit 37 start calculating the movement trajectory of the golf club 14. Thus, the support displacement calculation unit 36 and the club head displacement calculation unit 37 can securely follow the movement of the golf club 14 over the entire swing.

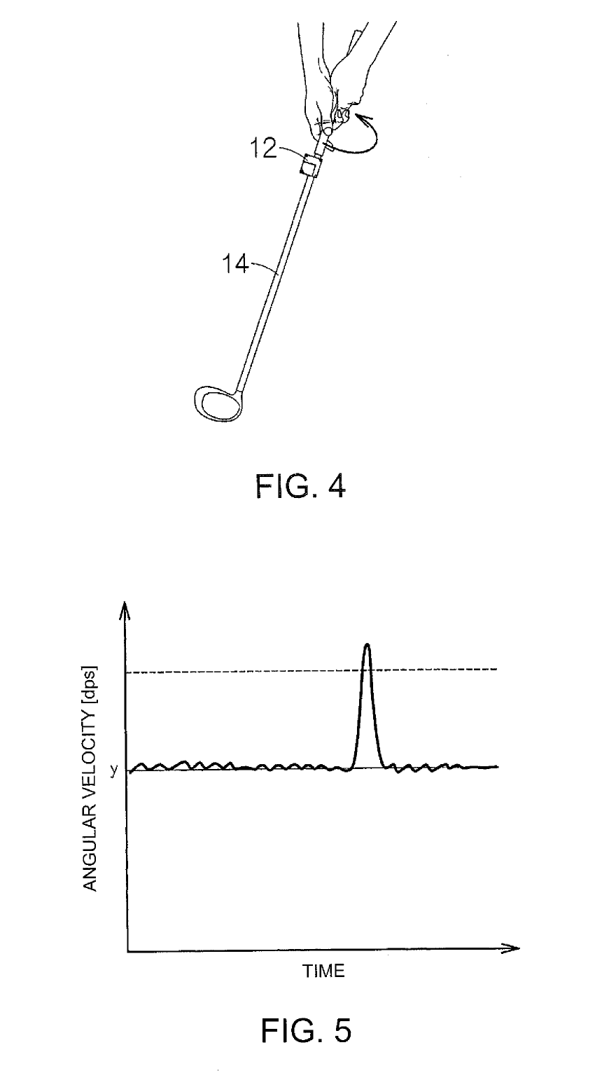

The subject carries out a specific movement before starting the swing movement. As the specific movement, a movement of rotating the golf club 14 in one direction about the center axis of the shaft 14a, as shown in FIG. 4, can be given as an example. Such a rotation of the golf club 14 can be realized by the subject turning the arms in one direction from the address posture. Here, the y-axis of the inertial sensor 15 is aligned with the center axis of the shaft 14a, as clear from FIG. 2. Therefore, as a result of such a movement, a large change, that is, a peak appears in the angular velocity about the y-axis in the output from the inertial sensor 15, as shown in FIG. 5. The waveform and size of such a peak is stored as an indicator in the memory 17 in advance. The calculation circuit 16 acquires the indicator of the specific movement from the memory 17. The calculation circuit 16 searches the output from the inertial sensor 15 for the indicator of the specific movement. For example, if a similar waveform is detected in the output from the inertial sensor 15, the calculation circuit 16 outputs a start signal to the main body unit 13. Alternatively, for example, if a value above a threshold value is detected in the angular velocity about the y-axis of the inertial sensor 15, the calculation circuit 16 outputs a start signal to the main body unit 13. As the main body unit 13 receives the start signal, the main body unit 13 starts analyzing the movement of the sporting gear or records useful data for such analysis. The golf swing analysis system 11 can start measurement securely at proper timing even when the subject is by himself or herself. Any redundant analysis can be avoided before the start of the swing.

In this embodiment, when the swing is finished, the subject carries out a specific movement. This specific movement may be the same as or different from the specific movement carried out at the start. However, if the specific movement at the start and the specific movement at the end are different from each other, confusion between the start and the end is prevented. The calculation circuit 16 searches the output from the inertial sensor 15 for the indicator of the specific movement. For example, if a similar waveform is detected in the output from the inertial sensor 15, the calculation circuit 16 outputs an end signal to the main body unit 13. Alternatively, for example, if a value above a threshold value is detected in the angular velocity about the y-axis of the inertial sensor 15, the calculation circuit 16 outputs an end signal to the main body unit 13. As the main body unit 13 receives the end signal, the main body unit 13 ends the measurement. At the same time, the main body unit 13 changes the sampling rate from the second sampling rate to the first sampling rate.

In the detection of the specific movement, the subject is required to be, for example, in the static posture of the address. As a result, the calculation circuit 16 detects the static state of the golf club 14 in a predetermined period before the indicator is detected. As the static state of the golf club 14 is established, the output from the inertial sensor 15 shows a detection value with a substantially constant value, as shown in FIG. 5. Therefore, the specific movement can become conspicuous in the output from the inertial sensor 15. The calculation circuit 16 can securely find the indicator in the output from the inertial sensor 15. The indicator can be prevented from being overlooked.

Moreover, when the start signal is received, the calculation processing circuit 19 in the main body unit 13 processes the output from the inertial sensor 15 at the second sampling rate (=1000 Hz). Therefore, the resolution of the motion analysis can be increased. Meanwhile, the calculation processing circuit 19 waits for execution of processing until receiving the start signal. At this point, the calculation processing circuit 19 processes the output from the inertial sensor 15 at the first sampling rate (=250 Hz). The frequency of processing is lowered. Therefore, unnecessary energy consumption can be restrained.

### 5. Specific Movement According to Second Specific Example

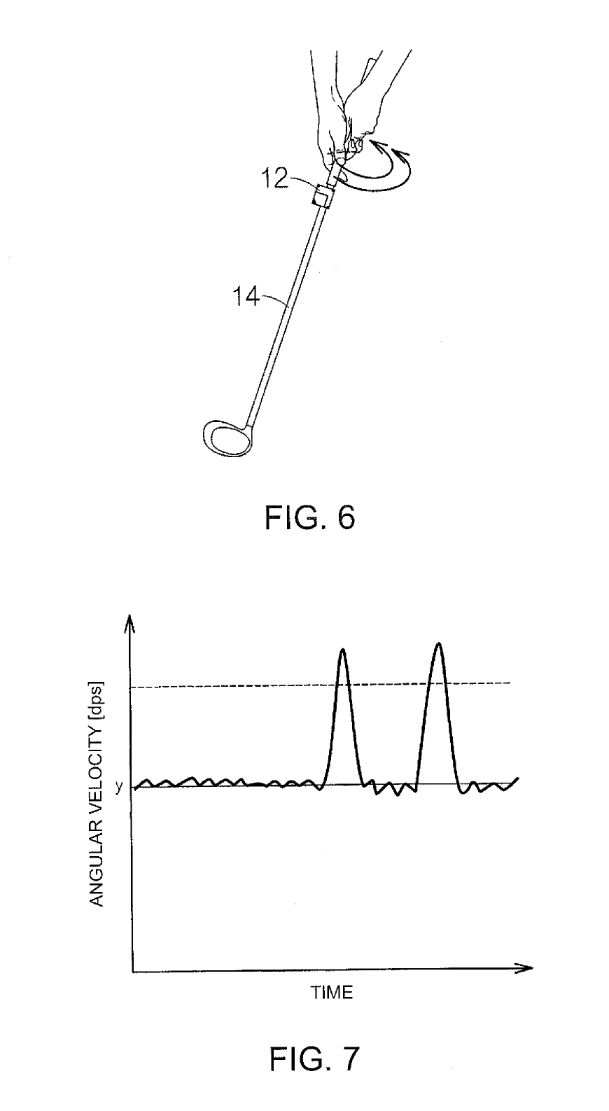

FIG. 6 schematically shows a specific movement according to a second specific example. In the second specific example, a movement of rotating the golf club 14 in one direction about the center axis of the shaft 14a is repeated. As a result of such a movement, large changes, that is, plural (in this example, two) peaks appear consecutively in the angular velocity about the y-axis in the output from the inertial sensor 15, as shown in FIG. 7. The waveform and size of such plural peaks are stored as an indicator in the memory 17 in advance. Thus, the indicator can include a repetition of a specific movement.

Generally, there are few exercises that include a repetition of a specific movement during a predetermined period. If the duration of the period is adjusted, the exercise does not include a repetitive movement during the period. Therefore, a repetitive movement detected during such a period can be considered to be an intentional movement by the subject. Such a repetitive movement is very unlikely to be mistaken for another movement. As a result, the sensor unit 12 can output the start signal or the end signal at appropriate timing. Therefore, erroneous output of the start signal or the end signal can be prevented.

### 6. Specific Movement According to Third Specific Example

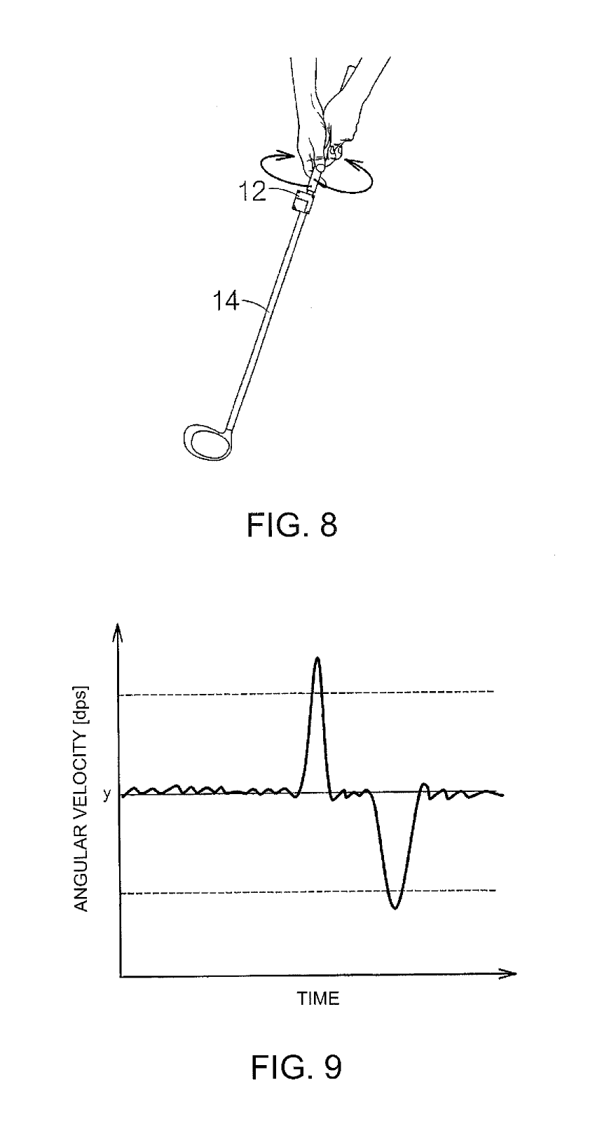

FIG. 8 schematically shows a specific movement according to a third specific example. In the third specific example, after a movement of rotating the golf club 14 in a first direction about the center axis of the shaft 14a, a movement of rotating the golf club 14 in a second direction that is opposite to the first direction about the center axis of the shaft 14a is carried out. Such a rotation of the golf club 14 can be realized by the subject turning his or her arms in the first direction from the address posture and returning to the address posture again, and subsequently turning his or her arms in the second direction and returning to the address posture again. As a result of such a movement, large changes, that is, peaks appear consecutively in the opposite directions in the angular velocity about the y-axis in the output from the inertial sensor 15, as shown in FIG. 9. The waveform and size of such peaks in the opposite directions are stored as an indicator in the memory 17 in advance. Thus, the indicator can include one specific movement, followed by a movement in the direction opposite to the former specific movement and paired with the former specific movement.

Generally, there are few exercises in which a specific movement and a movement in the opposite direction paired with the specific movement (for example, a mirror image) continue during a predetermined period. If the duration of the period is adjusted, the exercise does not include a continuation of a specific movement and a movement in the opposite direction during the period. Therefore, a continuation of a movement and a movement in the opposite direction during such a period can be considered to be an intentional movement by the subject. Such a continuation of a specific movement and a movement in the opposite direction is very unlikely to be mistaken for another movement. As a result, the sensor unit 12 can output the start signal or the end signal at appropriate timing. Therefore, erroneous output of the start signal or the end signal can be prevented.

### 7. Specific Movement According to Fourth Specific Example

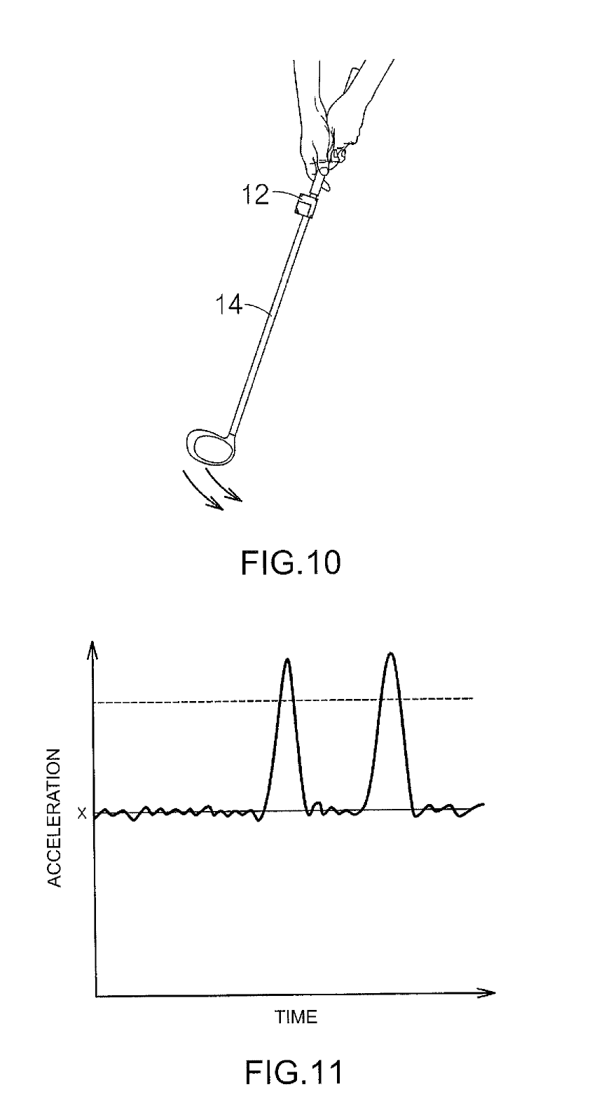

FIG. 10 schematically shows a specific movement according to a fourth specific example. In the fourth specific example, a movement of swinging the club head 14c in the direction of a target line, that is, in the ball hitting direction and thus applying an impact is carried out. As a result of such a movement, large changes, that is, plural (in this example, two) peaks appear consecutively in the acceleration in the x-axis direction in the output from the inertial sensor 15, as shown in FIG. 11. The waveform and size of such plural peaks are stored as an indicator in the memory 17 in advance. Here, the indicator may be specified by one peak or may be specified by movements in the opposite directions from the static state.

### 8. Specific Movement According to Fifth Specific Example

The indicator is formed, based on the recording of an actual measured value outputted from the inertial sensor 15. In other words, the indicator is formed, based on an actual movement of the subject or the sporting gear. The indicator is thus customized for each subject. The subject can register a familiar movement as the indicator in the memory 17 of the sensor unit 12. The subject can remember to carry out the specific movement according to the indicator. Thus, output of the start signal or the end signal can be reliably secured.

### 9. Configuration of Golf Swing Analysis System According to Second Embodiment

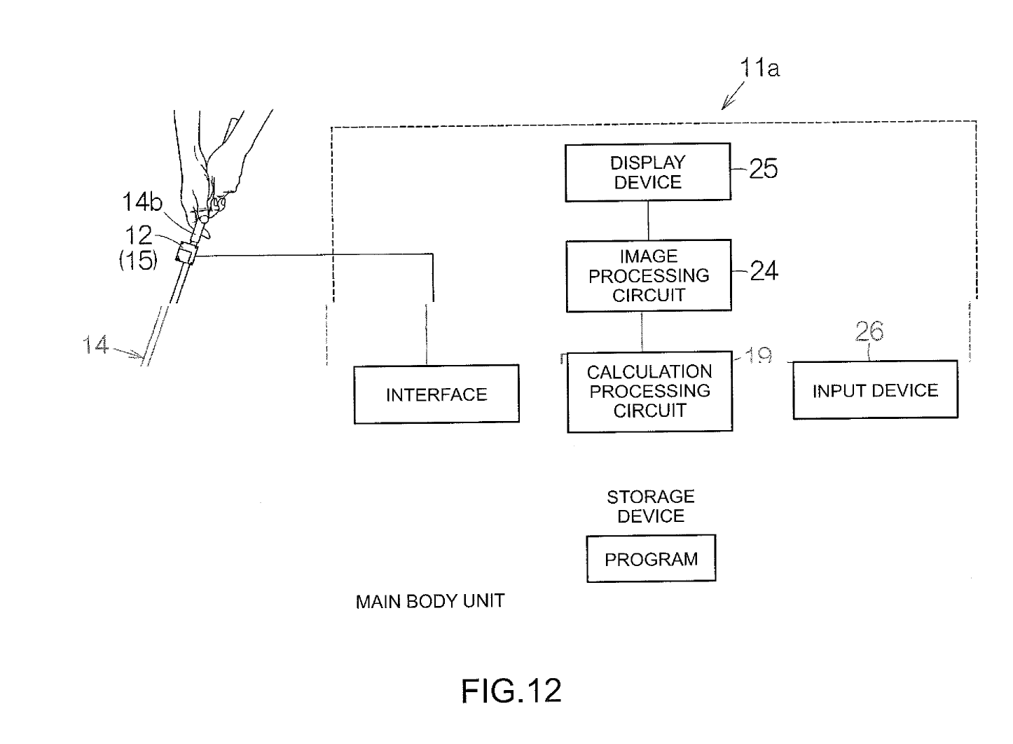

FIG. 12 schematically shows the configuration of a golf swing analysis system (motion analysis system) 11a according to a second embodiment of the invention. In the second embodiment, the calculation processing circuit 19 in the main body unit 13 is in charge of the function of the calculation circuit 16. The storage device 22 is in charge of the function of the memory 17. Therefore, the storage device 22 stores an indicator that is expressed by the output from the inertial sensor 15 and that specifies a specific movement of the golf club 14. If the indicator is detected in the output from the inertial sensor 15 while receiving the output signal from the inertial sensor 15, the calculation processing circuit 19 starts analyzing the movement of the golf club 14 or records useful data for such analysis. If the first indicator is detected in the output from the inertial sensor 15, the calculation processing circuit 19 processes the output from the inertial sensor 15 at the second sampling rate (=1000 Hz). The calculation processing circuit 19 processes the output from the inertial sensor 15 at the first sampling rate (=250 Hz) that is lower than the second sampling rate, until the first indicator is detected in the output from the inertial sensor 15. Such switching between the sampling rates may be realized by the switching unit 39 in the calculation processing circuit 19, as in the foregoing description.

### 10. Configuration of Golf Swing Analysis System According to Comparative Example

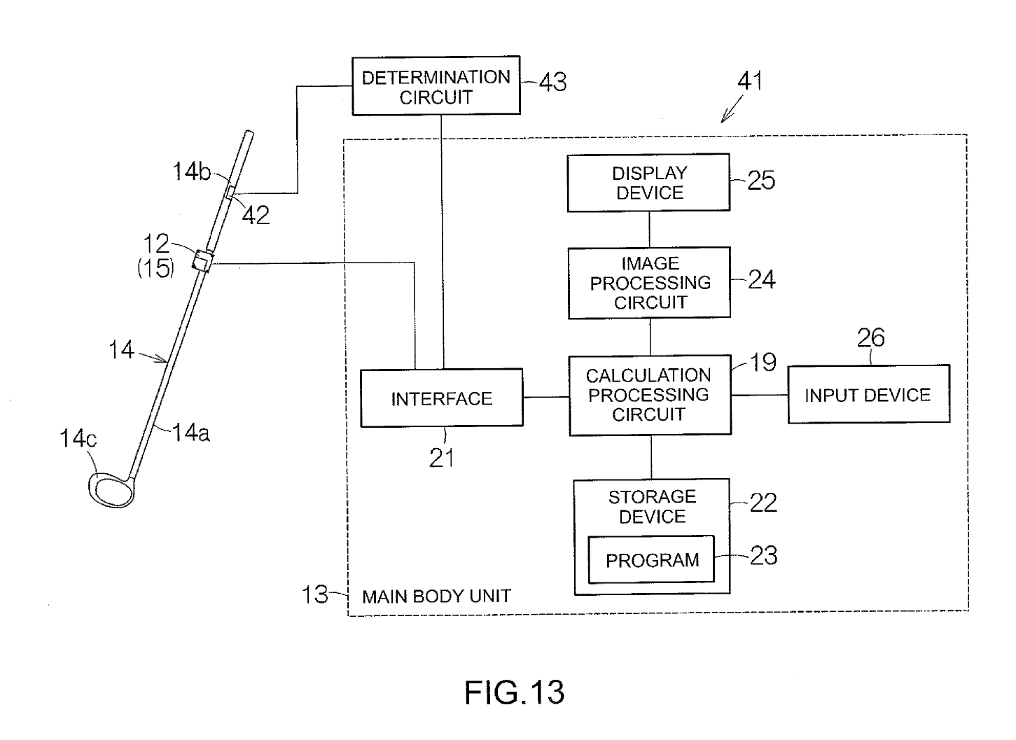

FIG. 13 schematically shows the configuration of a golf swing analysis system 41 according to a comparative example. The golf swing analysis system 41 has a light receiving sensor 42. The light receiving sensor 42 is embedded in the grip 14b of the golf club 14. The light receiving sensor 42 is arranged, for example, at a part covered by the right hand of a right-handed subject when the subject places his or her right hand on the grip 14b. The light receiving sensor 42 outputs different signals between a light receiving occasion and a light shielding occasion.

A determination circuit 43 is connected to the light receiving sensor 42. The determination circuit 43 outputs the start signal in response to the signal on the light shielding occasion from the light receiving sensor 42. Therefore, when light reception is interrupted by the subject's hand at the address, the start signal is sent to the main body unit 13 from the determination circuit 43. The other parts of the configuration are similar to the foregoing golf swing analysis system 11. The golf swing analysis system 41 according to the comparative example can securely start measurement at proper timing even when the subject is by himself or herself. Redundant analysis can be avoided before a swing is started. Moreover, the determination circuit 43 may be incorporated in the calculation processing circuit 19 in the main body unit 13. In such a case, the output from the light receiving sensor 42 may be sent to the calculation processing circuit 19 from the interface 21.

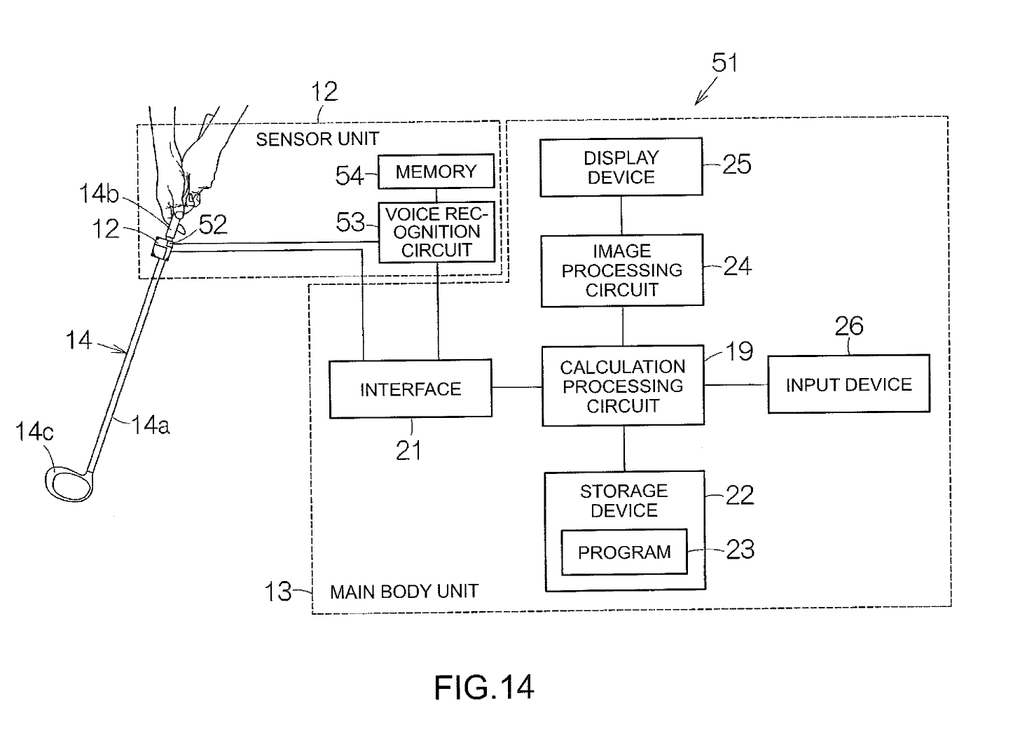

FIG. 14 schematically shows the configuration of a golf swing analysis system 51 according to another comparative example. The golf swing analysis system 51 has a microphone 52. The microphone 52 is incorporated, for example, in the sensor unit 12. The microphone 52 picks up sounds in the surroundings. A voice recognition circuit 53 is connected to the microphone 52. The voice recognition circuit 53 recognizes the subject's voice picked up by the microphone 52. For example, a memory 54 is connected to the voice recognition circuit 53. The memory 54 stores an indicator that is expressed by the output from the microphone 52 and that specifies a specific voice of the subject. As the indicator, for example, a voice speaking words like “start measurement” may be used. If the indicator is detected in the voice picked up by the microphone 52, the voice recognition circuit 53 outputs the start signal to the main body unit 13. The other parts of the configuration are similar to the foregoing golf swing analysis system 11. The golf swing analysis system 51 according to this comparative example can securely start measurement at proper timing even when the subject is by himself or herself. Redundant analysis can be avoided before a swing is started.

In the above embodiments, the individual function blocks in the calculation processing circuit 19 are realized according to the execution of the golf swing analysis software program 23. However, the individual function blocks may be realized by hardware without depending on software processing. Moreover, the golf swing analysis systems 11, 41, 51 may also be applied to swing analysis of other sporting gears held and swung by the hand (for example, a tennis racket, table tennis racket, baseball bat, or bamboo sword for kendo). Also, the embodiments can also be used for motion analysis in running, boxing and the like if the inertial sensor 15 is installed on the subject.

While the embodiments are described above in detail, a person skilled in the art can readily understand that various modifications can be made without substantially departing from the new matters and advantageous effects of the invention. Therefore, all such modifications are included in the scope of the invention. For example, in the specification and drawings, a term described along with a different term with a broader meaning or the same meaning at least once can be replaced with the different term in any part of the specification and drawings. Also, the configurations and operations of the inertial sensor 15, the golf club 14, the grip 14b, the club head 14c, the calculation processing circuits 19 and the like are not limited to those described in the embodiments, and various modifications can be made.

The entire disclosure of Japanese Patent Application No. 2013-141722, filed Jul. 5, 2013 is expressly incorporated by reference herein.

What is claimed is:

1. A motion detection device that specifies a movement of at least one of a subject and a sporting gear as an indicator of a trigger signal, using an output from an inertial sensor.

2. The motion detection device according to claim 1, wherein the indicator includes a repetition of the movement.

3. The motion detection device according to claim 1, wherein the indicator includes the movement and a movement in an opposite direction to the movement.

4. The motion detection device according to claim 1, further comprising a memory which stores the indicator.

5. The motion detection device according to claim 4, wherein the memory stores a peak part of the output from the inertial sensor as the indicator.

6. The motion detection device according to claim 4, wherein the memory stores plural peak parts of the output from the inertial sensor as the indicator.

7. The motion detection device according to claim 4, wherein the memory stores the output from the inertial sensor in a static state of at least one of the subject and the sporting gear on which the inertial sensor is installed.

8. The motion detection device according to claim 4, wherein the memory stores the indicator for subject.

9. The motion detection device according to claim 4, wherein the memory is loaded in a sensor unit in which the inertial sensor is loaded.

10. The motion detection device according to claim 1, further comprising a calculation circuit which, if the indicator is detected from the output from the inertial sensor, outputs the trigger signal and instructs a main body unit to carry out processing.

11. The motion detection device according to claim 10, wherein a first indicator and a second indicator may be specified as the indicator, and
the calculation circuit outputs the trigger signal to the main body unit to start measurement if the first indicator is detected from the output from the inertial sensor, and outputs the trigger signal to the main body unit to stop measurement if the second indicator is detected from the output from the inertial sensor.

12. The motion detection device according to claim 10, wherein the calculation circuit is loaded in a sensor unit in which the inertial sensor is loaded.

13. The motion detection device according to claim 1, wherein the inertial sensor is an angular velocity sensor, and
the indicator is specified using an angular velocity generated about an axis of a shaft portion of the sporting gear.

14. The motion detection device according to claim 1, wherein the inertial sensor is an acceleration sensor, and
the indicator is specified using an acceleration generated in the sporting gear.

15. A motion analysis system comprising:
the motion detection device according to claim 10; and
the main body unit executing processing in response to reception of the trigger signal.

16. The motion analysis system according to claim 15, wherein the main body unit processes the output from the inertial sensor at a first sampling rate before receiving the trigger signal and processes the output from the inertial sensor at a second sampling rate that is higher than the first sampling rate in response to reception of the trigger signal.

17. The motion analysis system according to claim 15, wherein the trigger signal is a signal indicating start or stop of execution of processing by the main body unit.

18. A motion detection device comprising:
a unit which stores a movement of a subject or a sporting gear as an indicator, using an output from an inertial sensor; and
a unit which outputs a trigger signal to a main body unit if the indicator is detected from the output from the inertial sensor.
